(19) United States
(12) Patent Application Publication
(10) Pub. No.: US 2013/0113163 A1
(43) Pub. Date: May 9, 2013

(54) Maintenance and Emergency Run Secondary Seal

(71) Applicants: George Thomson, Burlington (CA); Guojun Ren, Burlington (CA); Kenneth Ogle, Burlington (CA); Roberto Garcia, Burlington (CA)

(72) Inventors: George Thomson, Burlington (CA); Guojun Ren, Burlington (CA); Kenneth Ogle, Burlington (CA); Roberto Garcia, Burlington (CA)

(73) Assignee: THOMSON-GORDON GROUP, Burlington (CA)

(21) Appl. No.: 13/290,435

(22) Filed: Nov. 7, 2011

(51) Int. Cl. F16J 15/40; F16J 15/16

(52) U.S. Cl. 277/346; 277/500

(57) ABSTRACT

A maintenance and emergency run secondary seal mountable to a rotatable shaft is described. The seal includes a housing; a sealing ring having a double-tapered receiving channel located between two exterior surfaces and an interior wear surface; a lantern ring having a double-tapered profile for enabling engagement within the receiving channel of the sealing ring to form an air chamber between the sealing ring and the lantern ring; and an arrangement for directing and controlling pressurized air to the air chamber. The operating positions for the sealing ring are: where the sealing ring is spaced from the shaft, where a portion of the interior wear surface of the sealing ring is closed-in on the shaft to enable an emergency run secondary seal to permit shaft rotation and where the sealing ring is in full contact with the shaft to enable a static seal.

### FIELD OF THE DISCLOSURE

The described embodiments relate to a maintenance and emergency run secondary seal capable of operating as both a static and a dynamic seal to support a primary dynamic seal used in drive/propeller shafts for power driven vessels.

### BACKGROUND

Power driven vessels (such as ships and in-board motor boats) include a drive or propeller shaft that connects an engine or transmission inside the vessel directly to a propeller. The propeller shaft extends through a stuffing box or other type of seal at the point it exits the vessel's hull. A primary dynamic seal encircles the vessel's propeller shaft to prevent water from entering the vessel during operation and when stopped. Conventional static maintenance safety seals have been proposed to provide a back-up in case of a typical primary dynamic seal failure. The problem with this type of arrangement is that conventional static seals only block water penetration when activated: use of the vessel is not recommended since the propeller shaft should not freely rotate after static maintenance safety seal activation due to the fact that friction of the engaged seal on the shaft creates heat that can destroy the seal.

Although emergency running safety seals have been proposed and are implemented in some vessels they are typically complex duplications of the primary dynamic seal and are thus not a cost effective solution in many applications.

As a result, there is a continuing need to improve maintenance and emergency run secondary seals that enable both static and dynamic seal functionality with a simplified structure and that can permit ready cost effective retrofitting to existing vessels or installation on new builds.

### SUMMARY

It is an object of the described embodiments to provide a maintenance and emergency run secondary seal for a vessel having a rotatable shaft that can provide both static and dynamic seal functionality to support a traditional primary dynamic seal in case of failure to enable a safe return to port for repair of a damaged primary seal.

Certain exemplary embodiments can provide a maintenance and emergency run secondary seal mountable to a rotatable shaft, the seal comprising: a housing; a sealing ring having a double-tapered receiving channel located between two exterior surfaces and an interior wear surface, the sealing ring being mounted in the housing; a lantern ring having a double-tapered profile for enabling engagement within the double-tapered receiving channel of the sealing ring to form an air chamber between the sealing ring and the lantern ring at a base of the double-tapered receiving channel; and means for directing and controlling pressurized air to the air chamber to enable three operating positions for the sealing ring: a first position where the sealing ring is spaced from the shaft, a second position where a portion of the interior wear surface of the sealing ring is closed-in on the shaft to enable an emergency run secondary seal to permit shaft rotation and a third position where the sealing ring is in full contact with the shaft to enable a static seal.

Certain exemplary embodiments can also provide a maintenance and emergency run secondary seal for a rotatable shaft having an axial direction, the seal comprising: a housing having an air track for receiving and directing pressurized air, the housing being mountable about the axial direction of the shaft; a sealing ring mounted in the housing and being in fluid communication with the air track of the housing, the sealing ring having an interior wear surface including a center region defined between an outboard edge and an inboard edge; and a lantern ring mounted within the sealing ring, the lantern ring having a plurality of air passages to enable pressurized air to pass through to the sealing ring, wherein the sealing ring being operable from a stand-by position where the sealing ring is spaced from the shaft in rotation; a partially activated position where a portion of the interior wear surface is partially closed-in to the shaft and a fully activated position where the interior wear surface is in full contact with the shaft.

### BRIEF DESCRIPTION OF THE DRAWINGS

FIG. 1 illustrates a partial cutaway perspective view of a maintenance and emergency run secondary seal (MERSS) according to an embodiment;

FIG. 2 illustrates three views of the sealing ring shown in FIG. 1 according to an embodiment;

FIG. 3 illustrates three views of the lantern ring shown in FIG. 1 according to an embodiment;

FIG. 4 illustrates a cross-sectional view of the MERSS of FIG. 1 mounted about a rotatable shaft;

FIGS. 5A and 5B illustrate cross-sectional views of the MERSS of FIG. 1 in a stand-by operating position (i.e., MERSS is deactivated) according to an embodiment;

FIG. 5C illustrates a cross-sectional view of the MERSS of FIG. 1 in an emergency dynamic operating position (i.e., MERSS is partially activated with seal/shaft contact) according to one embodiment;

FIG. 5D illustrates a cross-sectional view of the MERSS of FIG. 1 in another emergency dynamic operating position (i.e., MERSS is partially activated with a seal/shaft gap) according to another embodiment; and

FIGS. 5E and 5F illustrate cross-sectional views of the MERSS of FIG. 1 in a secondary maintenance/static sealing position (i.e., MERSS is fully activated with seal/shaft in sealing contact).

### DETAILED DESCRIPTION

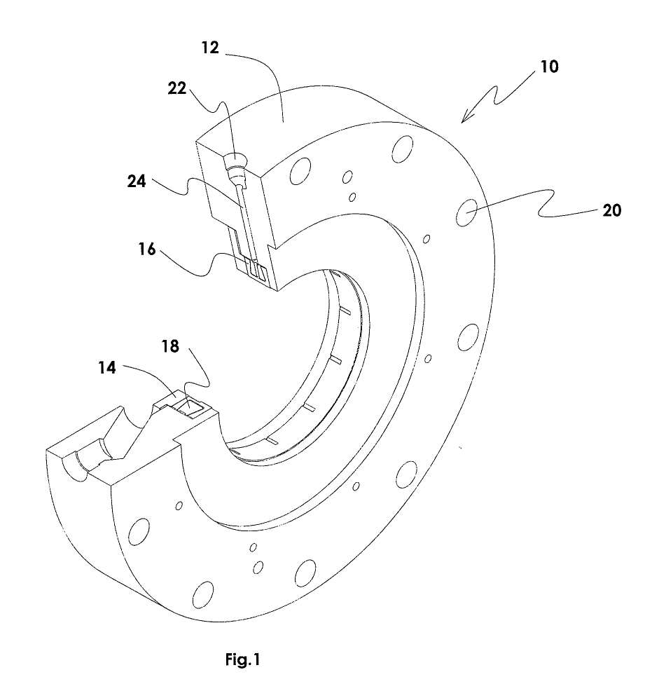

FIG. 1 shows a maintenance and emergency run secondary seal (MERSS) 10 capable of operating as both a static and dynamic seal to support a traditional primary dynamic seal (not shown). The MERSS 10 includes a housing 12 (typically metal) and a housing cover plate 14 for receiving and retaining a pair of nested rings: a sealing ring 16 and a lantern ring 18. The housing 12 includes a plurality of mounting apertures 20 to accommodate installation of the MERSS 10 to a bulkhead of a vessel.

The housing 12 also includes an air inlet 22 and an air track 24 for receiving and directing pressurized/compressed air. The air track 24 extends from the air inlet 22 to the pair of nested rings 16, 18. The sealing ring 16 and the lantern ring 18 are removably mounted in the housing 12 and can be individually serviced and replaced as required by removing the housing cover plate 14.

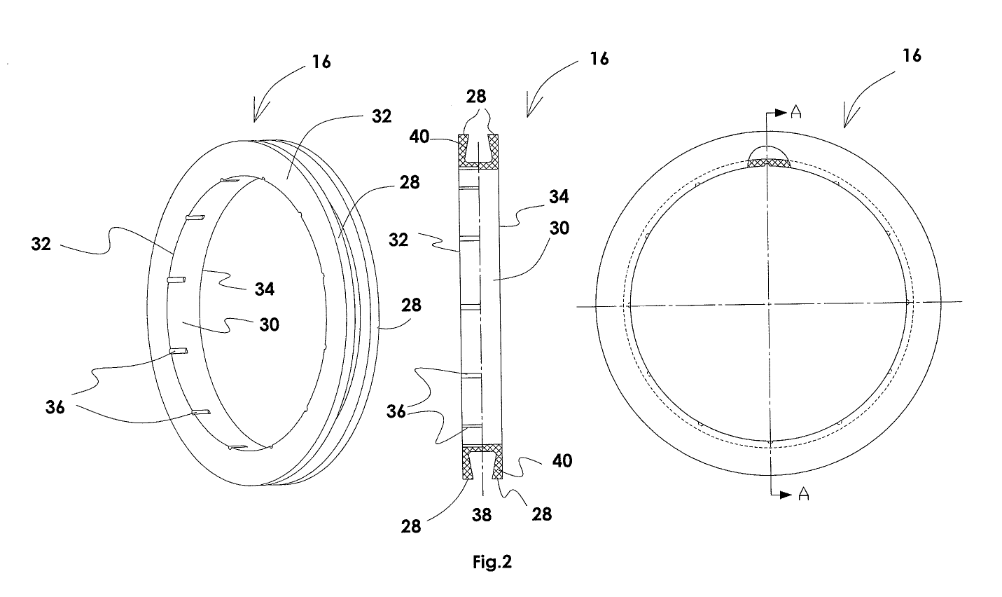

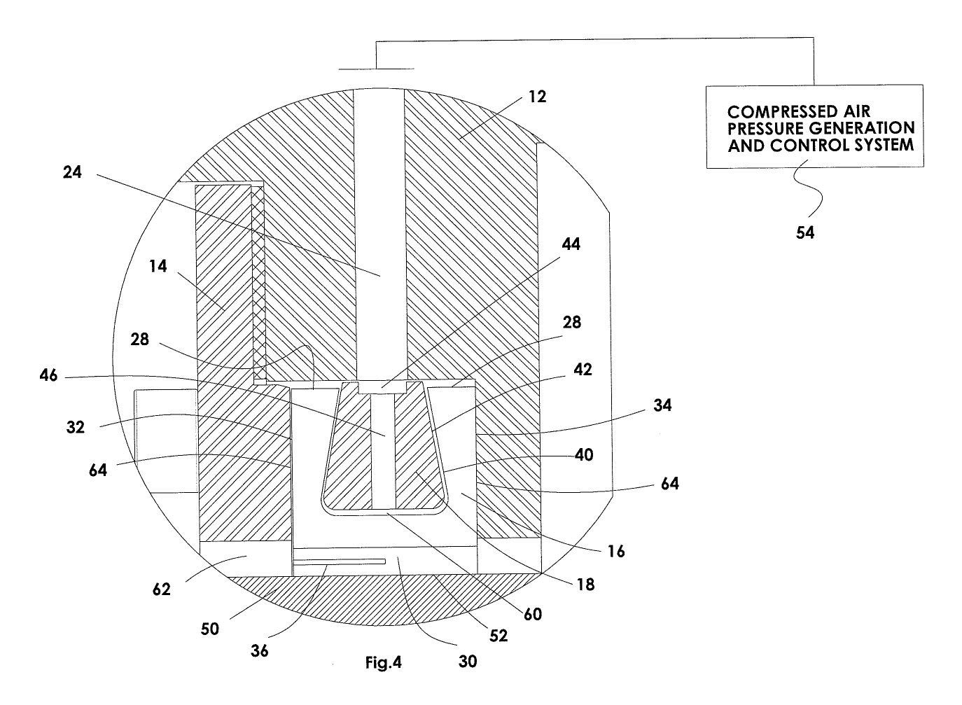

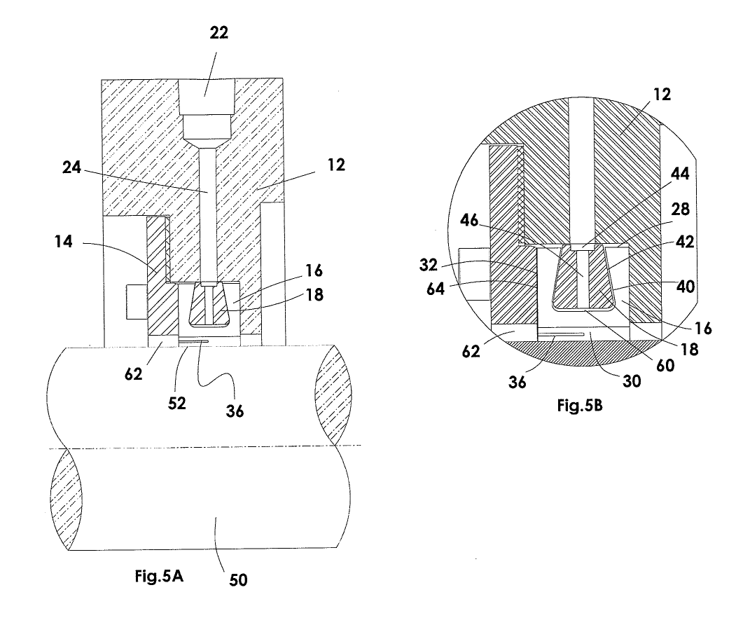

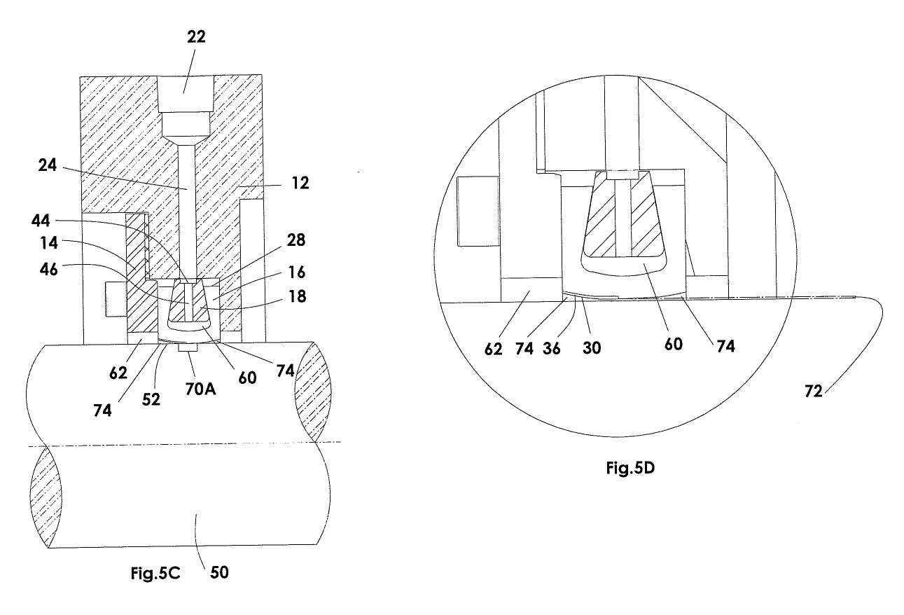

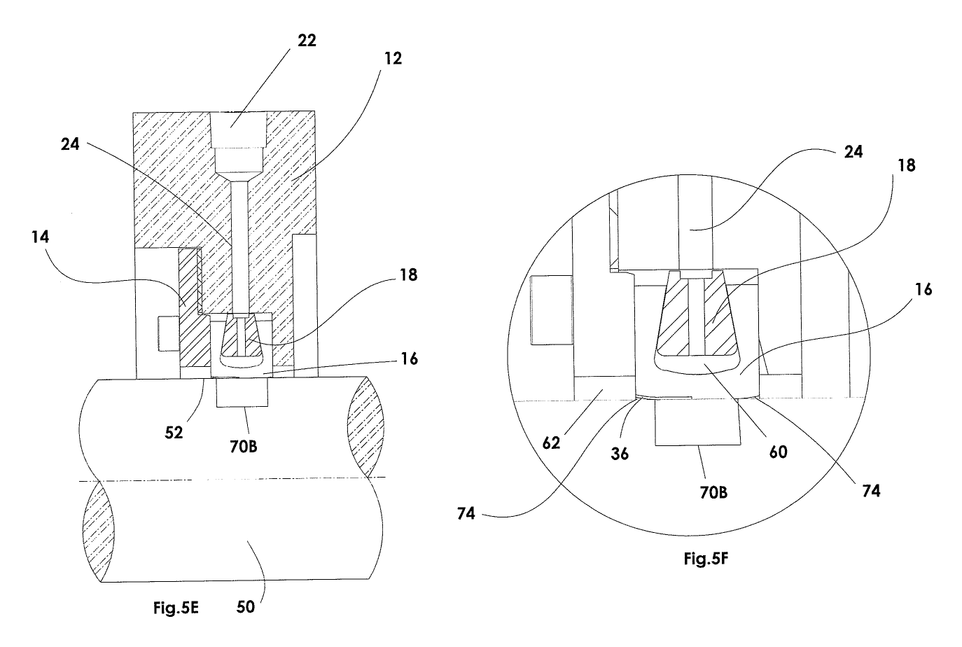

Further details of the sealing ring 16 are illustrated in the various views of FIG. 2. The sealing ring 16 has two exterior surfaces 28 and one interior wear surface 30, which are defined between an outboard edge 32 and an inboard edge 34. The sealing ring 16 includes a plurality of grooves 36 extending from the outboard edge 32 to approximately a center region 38 of the interior wear surface 30. The grooves 36 are axially aligned (i.e., in relation to a rotatable shaft 50 mounted in the MERSS 10—shown in FIGS. 5A-5F) and are approximately equally spaced from each other and extend circumferentially about the sealing ring 16. The grooves 36 channel water to encourage the generation of a hydro-dynamic film wedge along the interior wear surface 30 of the sealing ring 16 to reduce frictional heat produced when a shaft is rotating in the MERSS 10 as discussed in more detail in FIGS. 5A-F.

The size of the grooves 36 can range from 1.5 to 2.0 mm in width and from 1.0 to 1.5 mm in depth depending on the size of the sealing ring 16. The number of grooves 36 varies based on the diameter of the sealing ring 16. The diameter of the sealing ring 16 will vary based on the size of the rotatable shaft 50 mounted in the MERSS 10.

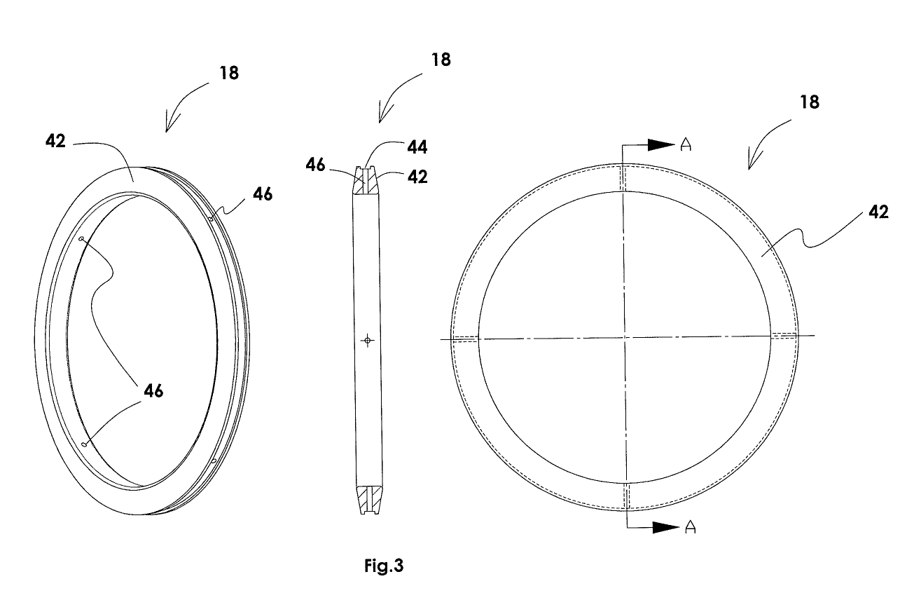

The sealing ring 16 has a double-tapered receiving channel 40 for receiving a matched double-tapered profile 42 of the lantern ring 18 (discussed further in FIG. 3).

The sealing ring 16 is made from a hard, self-lubricating, elastomeric polymer alloy designed to reduce friction and frictional heat generation when in contact with a rotating shaft. The elastomeric material used in the seal ring 16 has a high mechanical strength and hardness (in the range of 85 to 95 A), and has appropriate elasticity, tear strength and abrasion resistance to provide a sealing function.

Further details of the lantern ring 18 are illustrated in the various views of FIG. 3. The lantern ring 18 includes a double-tapered profile 42 to match the double-tapered receiving channel 40 of the sealing ring 16. The lantern ring 18 also includes a circumferential channel 44 and a plurality of circumferentially spaced air passages 46 extending through the lantern ring 18. The channel 44 and air passages 46 are designed to permit pressurized/compressed air from passing from the air track 24 in the housing 12 through the lantern ring 18 to the sealing ring 16.

A magnified cross-section of the MERSS 10 mounted about a rotatable shaft 50 (such as a propeller shaft) having an outside surface 52 is illustrated in FIG. 4. When the lantern ring 18 is nested within the sealing ring 16, an air chamber/region 60 is formed at the bottom of the double-tapered receiving channel 40 of the sealing ring 16. The housing cover plate 14 is arranged to provide a water receiving region 62 to provide water to the grooves 36 of the sealing ring 16 as previously discussed. The housing 12 and cover plate 14 provide engagement surfaces 64 for the sealing ring 14, which is discussed in more detail in FIGS. 5A-F.

Operating Positions

The MERSS 10 has three primary operating positions managed by controlling the displacement of the lantern ring 18 and expansion of the sealing ring 16 using pressurized/compressed air managed by a compressed air pressure generation and control system 54 (see FIG. 4). Operability between the three primary operating positions is enabled by the relationship between the double-tapered profile 42 of the lantern ring 18; the double-tapered receiving channel 40 of the sealing ring 16 and the engagement surfaces 64 of the housing 12 and cover plate 14.

The three primary operating positions are:

FIGS. 5A and 5B

(1) A stand-by (or deactivated) position: defined as the sealing ring 16 being spaced apart from the shaft 50. The MERSS 10 operates in this position when a primary dynamic seal of the vessel is functioning properly. The first deactivated position is illustrated in FIGS. 5A and 5B.

FIGS. 5C and 5D

(2) An emergency dynamic operating (or partially activated) position: defined as (a) a small center portion 70A of the sealing ring 16 being in slight contact with the shaft 50 as shown in FIG. 5C or (b) the sealing ring 16 being proximate (i.e., no direct contact) to the shaft 50 thereby defining a gap 72 as shown in FIG. 5D. Typical operating tolerances of the gap 72 between the sealing ring 16 and the outside surface 52 of the shaft 50 is in the range of approximately 0.1 mm to 0.5 mm The principle of operating in the partially activated position option (b) is to allow rotation of the shaft 50 with minimal acceptable water leakage to permit operation of the vessel. In the partially activated positions (either option (a) or (b)), the surface of the sealing ring 16 is deflected more at the center than at the edges to form a pair of open wedge regions 74 between the sealing ring 16 and the outside surface 52 of the shaft 50.

To deploy the MERSS 10 from the stand-by position to the emergency dynamic operating position compressed air is directed and controlled by the control system 54 to the air inlet 22 through the air track 24 in the housing 12 through the air passages 46 of the lantern ring 18 to deflect the sealing ring 16. By controlling the pressure of the compressed air using the compressed air pressure generation and control system 54, the flow directed through the air track 24 of the housing 12, will close-in the sealing ring 16 to the outside surface 52 of the shaft 50 to form the gap position 72 (FIG. 5D) or a slight contact position 70A (FIG. 5C). In either case, with the hydrodynamic film formed on the interior wear surface 30 of the sealing ring 16 generated by water flowing from the grooves 36 (to prevent overheating of the sealing ring 16) and the shaft 50 being allowed to rotate enables the vessel to operate without a functioning primary dynamic seal.

The double-tapered shapes of the lantern ring 18 and sealing ring 16 develops a clamping force between the sealing ring 16 and the engagement surfaces 64 of the housing 12 and cover 14 (see FIG. 4) when the sealing ring 16 is pressurized (in the partially activated position). This clamping force prevents the sealing ring 16 from rotating due to friction between the rotating shaft 50 and the interior wear surface 30.

FIGS. 5E and 5F

(3) A secondary static sealing (or fully activated) position: defined as a significant portion 70B of the sealing ring 16 being in contact with the outside surface 52 of the shaft 50 to reduce water leakage to a level that will permit maintenance operations to be performed on a defective primary dynamic seal. The third fully activated position is shown in FIGS. 5E and 5F.

To deploy the MERSS 10 from either the stand-by position or the emergency dynamic operating position to the secondary sealing position compressed air from the compressed air pressure generation and control system 54 is directed and controlled by the control system 54 to the air inlet 22 through the air track 24 in the housing 12 through the air passages 46 of the lantern ring 18 to deflect the sealing ring 16 effectively fully press the interior wear surface 30 against the outside surface 52 of the shaft 50 to provide an effectively water tight seal.

To return the MERSS 10 from either the secondary static sealing position or the emergency dynamic sealing position to the stand-by position air is bled from the sealing ring 16 by removing the compressed air flow from the air track 24 in the housing 12 using the compressed air pressure generation and control system 54. This air bleed operation will gradually separate the sealing ring 16 from the shaft 50 to return the sealing ring 16 to the standby position of FIGS. 5A/B.

In summary, embodiments of the MERSS 10 are designed to be used in conjunction with a conventional primary dynamic seal for a vessel's propeller shaft. The MERSS 10 is capable of functioning as a static maintenance safety seal to allow repair of sealing elements of the primary dynamic seal and for use as an emergency secondary dynamic seal that allows the vessel to return to port safely under its own power when the primary dynamic seal is damaged or becomes unserviceable during operation.

In particular, when a vessel is stopped in a safe location and all parts and technical expertise are available for a scheduled repair of a primary dynamic seal, the MERSS 10 can be pressurized to the fully activated position (FIGS. 5E/F) to effect a sufficiently watertight seal around the propeller shaft to allow the primary dynamic shaft seal to be repaired with no (or limited) entry of water into the vessel. However, if there is a failure of the primary dynamic seal while the vessel is sailing and it is not possible to stop and repair the primary seals, the MERSS 10 is pressurized to a lesser degree (FIGS. 5C/D) to effectively act as an emergency dynamic seal to allow the vessel to continue to sail (at a reduced speed) until it returns to port and repair of the primary dynamic seal can be safely performed. The MERSS 10 can function as a back-up primary dynamic seal by controlling the expansion of the sealing ring 16 (as discussed above) to permit shaft rotation and limiting the friction produced by close-in on a rotating shaft versus conventional safety seals requirement that there be no shaft rotation.

### FIGURE REFERENCES

10 maintenance and emergency run secondary seal (MERSS)
12 housing
14 housing cover plate
16 sealing ring
18 lantern ring
20 mounting apertures
22 air inlet (in housing)
24 air track (in housing)
28 exterior surfaces (of sealing ring)
30 interior wear surface (of sealing ring)
32 outboard edge (of sealing ring)
34 inboard edge (of sealing ring)
36 grooves (in sealing ring)
38 center region (of interior wear surface of sealing ring)
40 double-tapered receiving channel (of sealing ring)
42double-tapered profile (of lantern ring)
44 circumferential channel (of lantern ring)
46 air passages (of lantern ring)
50 shaft (propeller, etc)
52 outside surface (of shaft)
54 compress air pressure generation and control system
60 air chamber/region (between lantern and sealing ring)
62 water receiving region
64 engagement surfaces (of housing/cover)
70A small contact surface (sealing ring to shaft surface)
70B large contact surface (sealing ring to shaft surface)
72 gap (sealing ring to shaft surface)
74 wedge regions (sealing ring to shaft surface)

1. A maintenance and emergency run secondary seal mountable to a rotatable shaft, the seal comprising:
a housing;
a sealing ring having a double-tapered receiving channel located between two exterior surfaces and an interior wear surface, the sealing ring being mounted in the housing;
a lantern ring having a double-tapered profile for enabling engagement within the double-tapered receiving channel of the sealing ring to form an air chamber between the sealing ring and the lantern ring at a base of the double-tapered receiving channel; and
means for directing and controlling pressurized air to the air chamber to enable three operating positions for the sealing ring: a first position where the sealing ring is spaced from the shaft, a second position where a portion of the interior wear surface of the sealing ring is closed-in on the shaft to enable an emergency run secondary seal to permit shaft rotation and a third position where the sealing ring is in full contact with the shaft to enable a static seal.

2. The seal of claim 1, further comprising a housing cover plate for removably retaining the sealing ring and the lantern ring in the housing.

3. The seal of claim 2, wherein the sealing ring is arranged in the housing to generate a clamping force to prevent rotation between the sealing ring, the housing cover plate and the housing when in the second position.

4. The seal of claim 1, wherein interior wear surface of the sealing ring includes a plurality of circumferentially spaced grooves for receiving and directing water flow for establishing a hydro-dynamic film wedge on the interior wear surface when in the second position.

5. The seal of claim 1, wherein the housing includes an air inlet and an air track in fluid communication with a plurality of air passages formed in the lantern ring and the means for directing and controlling pressurized air via a compress air pressure generation and control system that is connectable to the air inlet of the housing.

6. A maintenance and emergency run secondary seal for a rotatable shaft having an axial direction, the seal comprising:
a housing having an air track for receiving and directing pressurized air, the housing being mountable about the axial direction of the shaft;
a sealing ring mounted in the housing and being in fluid communication with the air track of the housing, the sealing ring having an interior wear surface including a center region defined between an outboard edge and an inboard edge; and
a lantern ring mounted within the sealing ring, the lantern ring having a plurality of air passages to enable pressurized air to pass through to the sealing ring, wherein the sealing ring being operable from a stand-by position where the sealing ring is spaced from the shaft in rotation; a partially activated position where a portion of the interior wear surface is partially closed-in to the shaft and a fully activated position where the interior wear surface is in full contact with the shaft.

7. The seal of claim 6, wherein the sealing ring includes a plurality of grooves for receiving and directing water flow, the plurality of grooves being circumferentially distributed about the sealing ring from the outboard edge to the inboard edge for producing a hydro-dynamic film wedge to reduce friction and remove frictional heat produced when the sealing ring is in the partially activated position.

8. The seal of claim 7, wherein each of the plurality of grooves extends from the outboard edge to approximately the center region of the sealing ring.

9. The seal of claim 6, wherein the sealing ring includes a double-tapered receiving channel and the lantern ring includes a matched double-tapered profile to enable nesting of the lantern ring in the sealing ring, whereby when in the partially activated position a clamping force is established between the sealing ring and the housing to prevent rotation of the sealing ring due to the rotation of the shaft.

10. The seal of claim 9, wherein the sealing ring is deflectable a greater amount at the center region of the interior wear surface than at outboard and inboard edges when in the partially activated position to establish a gap between the interior wear surface and the shaft to enable operable rotation of the shaft.

11. The seal of claim 9, wherein the sealing ring is deflectable a greater amount at the center region of the interior wear surface than at outboard and inboard edges when in the partially activated position to establish a partial contact region and two wedge regions between the interior wear surface and the shaft to enable operable rotation of the shaft.
